(19) United States
(12) Patent Application Publication
(10) Pub. No.: US 2003/0089465 A1
(43) Pub. Date: May 15, 2003

(54) Process for producing microcrystalline cellulose

(76) Inventors: David Schaible, Ulster Park, NY (US); Ivan Charles Brinkman, Cedar Rapids, IA (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/010,907

(22) Filed: Nov. 2, 2001

(51) Int. Cl. D21C 9/00; D21C 3/26; D21B 1/04; C08B 1/00

(52) U.S. Cl. 162/19; 162/56; 162/28; 536/56; 536/124; 536/126; 162/78; 162/90; 162/84

(57) ABSTRACT

A process is provided for preparing a commercially acceptable pharmaceutical grade microcrystalline cellulose which comprises: a) repulping a pulp, the pulp having a composition, b) pressing the pulp obtained in a; c) decompacting of the pulp obtained in b; d) feeding the pulp obtained in c) into a pre-heated reactor; e) cooking the pulp in the reactor until the pulp obtains a desired degree of polymerization, said cooking being performed at a temperature, a time, and a pressure which is a function of the desired degree of polymerization and the composition of the pulp, the cooked pulp being hydrolyzed cellulose; f) partially depressurizing the reactor; g) injecting water into the reactor; h) discharging the hydrolyzed cellulose from the reactor, i) filtrating the hydrolyzed cellulose; j) deaggregating the hydrolyzed cellulose of step i; and k) drying the hydrolyzed cellulose to form microcrystalline cellulose.

### FIELD OF THE INVENTION

The present invention relates to a process for the production of microcrystalline cellulose.

### DESCRIPTION OF PRIOR ART

Canadian application No. CA 2,313,261 (JOLLEZ) describes a process for the production of microcrystalline cellulose. This process is characterised in that the pulp obtained at the end of a thermo mechanical pulping step is submitted to a sudden and violent depressurisation and a shear force. This step has for effect the production of a non-selective fragmentation of the microcrystalline cellulose resulting in the production of impurities by the oxidation during and after the explosion of the pulp.

Canadian patent No. CA 1,198,703 (DELONG) describes a process which generates a mixture of sugar and cellulose more or less degraded. This process uses wood as the starting material and sulphuric acid, sulphurous (SO₂) or hydrochloric acid.

Canadian patent No. CA 2,137,890 (AKZO) describes the conversion of cellulose fibers derived from a conventional process, into microcrystalline cellulose by using benign reactives like O₂ and CO₂. More particularly, it shows that a low degree of polymerisation can be obtained by the application of high-pressure at 140° to 180° C. for 15 minutes to 5 hours on aqueous suspensions of cellulose (solid/liquid ratio of 1/8 to 1/20) in the presence of O₂ and CO₂ in autoclaves in non-continuous mode.

### SUMMARY OF THE INVENTION

A first object of the present invention is to provide a process for the manufacture of microcrystalline cellulose having a fibrous appearance and the integrity of which is kept.

A second object of the present invention is to provide a process for the production of microcrystalline cellulose that does not necessitate the use of any mineral acids, sulphur dioxide or carbon dioxide.

A third object of the present invention is the production of microcrystalline cellulose in the absence of violent non-selective depressurisation. The present process allows the application of a controlled depressurisation, which in turn permits a high yield of microcrystalline cellulose, at all conditions, while limiting the production of non-desirable derivatives.

A fourth object of the present invention is to provide a process which can produce a commercially acceptable pharmaceutical grade microcrystalline cellulose product in the absence of violent nonselective depressurization.

In accordance with an embodiment of the present invention, a process is provided for manufacturing hydrolyzed cellulose suitable for use in preparing microcrystalline cellulose, comprising:

a) preparation of a pulp by repulping,

b) pressing of the pulp obtained in a),

c) decompaction of the pulp obtained in b),

d) feeding of the pulp obtained in c) into a pre-heated reactor,

e) cooking of the pulp at a temperature, a time and a pressure allowing to obtain a pulp having a desired degree of polymerisation (the cooked pulp being hydrolysed cellulose),

f) cooling and partial controlled depressurisation of the reactor by purging the reactor, followed by a water injection into the jacket of the reactor and directly into the reactor, and

g) filtration of the pulp obtained in f).

It should be noted that the appropriate time, temperature, and pressure for the cooking in step (e) will be dependent not only upon the desired degree of polymerization, but also on the particular pulp used as a starting material. Moreover, it should be noted that the desired degree of polymerization may differ from pulp to pulp.

In certain further embodiments of the present invention, a commercially acceptable pharmaceutical grade microcrystalline cellulose product is produced by performing steps a through g above, and then:

h) neutralizing a solution of the hydrolyzed cellulose and water to obtain a neutralized solution having a pH of at least 5.5, and preferably between 5.5 and 7.5,

i) applying a shear force to deaggregate the hydrolyzed cellulose particles and provide a more uniform hydrolyzed cellulose material, and

j) spray drying the hydrolyzed cellulose.

One of the advantages provided by such a process is that there is no disorganised destruction of the cell structure such as it is seen during a violent depressurisation in the processes using a thermo-mechanical pulping step. In fact, contrary to the cases of thermo-mechanical pulping, in the process of the present invention, there is no exposure of the burst material to air, light or hot metallic sides. Thus there is no formation, or very limited formation of oxycellulose or non-desired functionalisations since such formation is favoured, in thermo-mechanical processes by the contact of the fibers to air and metals at the flashing temperature.

Another advantage provided by the process of the invention is that the filtration of the treated product is much faster, thanks to the absence of fine fragments resulting from the random and non-selective breaking of the cellulose chains during the violent depressurisation, which occurs during the thermo-mechanical treatments like steam explosion treatment.

A further advantage of the process of the invention is that controlled depressurisation prevents a disorganised destruction of the cell and allows a high yield of microcrystalline cellulose.

In one embodiment in which the pulp is Temalfa 93, a yield of higher than 95% can be obtained using the process of the present invention.

It is believed that the higher yields achieved in the present invention can be explained by explain the decrease of the suspended solids and dissolved pollutants in the water phase by more than half compared to a thermo-mechanical pulping process. It is further believed that the decrease is due to the absence of non-selective fragmentation in the process of the present invention and the absence of products of decomposition, which are generated by oxidation during and after the explosion in a thermo-mechanical pulping process.

The process of the invention also has the advantage of allowing more efficient brightening or bleaching, facilitated by the absence of fines resulting from the random breaking of the cells in a conventional steam treatment which retain the impurities and consume much more bleaching reactives. In preferred embodiments, the yield of this method is superior to 99% and the peroxide brightens the pulp without delignifying or contributing to the purification of the surrounding impure environment, like in the case of explosive treatments. The degree of brightness of a bleached final product is much higher than in any other treatment by thermo-mechanical pulping.

Another advantage provided by the process of the present invention is that the process is carried out in a low acidity environment. The advantages of low acidity resides on the fact that it does not cause a massive depolymerization of the cellulose as in the case of the DELONG patent in which the starting material is wood and the final product is a cellulose that has been cut in a non-selective fashion therefore, giving a mix of sugars and fragments of cellulose chains in the presence of numerous degradation products like furfural and other products coming from hemicelluloses or lignin.

The present invention and its advantages will be more easily understood after reading the following non-restrictive description of the preferred embodiments thereof, made with reference to the hereinbelow drawings.

### BRIEF DESCRIPTION OF THE DRAWINGS

FIG. 1 is a side view of the apparatus that is adapted to carry out the process of the present invention.

FIG. 2 is a photographic representation of the Temalfa cellulose 93 TEM prior to being processed.

FIG. 3 is a photographic representation of the Temalpha cellulose of FIG. 1, treated by a steam explosion process.

FIG. 4 is a photographic representation of the Temalpha cellulose of FIG. 1, treated by the process of the present invention.

FIG. 5 illustrates the compaction and flow characteristics of Example E as compared to Emcocel 50 M.

FIG. 6 shows the results of the USP/NF tests on Example E.

### DETAILED DESCRIPTION OF THE INVENTION

As mentioned hereinabove, the process of the invention comprises the steps of:

a) preparing a pulp by repulping,

b) pressing the pulp obtained in a),

c) decompacting the pulp obtained in b),

d) feeding the pulp obtained in c) into a pre-heated reactor,

e) cooking the pulp at a temperature, a time and a pressure allowing to obtain a pulp having a desired degree of polymerisation (the cooked pulp being hydrolyzed cellulose),

f) cooling and partial depressurising the reactor by purging the reactor, followed by a water injection into the jacket of the reactor and directly into the reactor, and

g) filtrating the pulp obtained in f).

It should be noted that the appropriate time, temperature, and pressure for the cooking in step (e) will be dependent not only upon the desired degree of polymerization, but also on the particular pulp used as a starting material. Moreover, it should be noted that the desired degree of polymerization may differ from pulp to pulp.

In certain further embodiments of the present invention, a commercially acceptable pharmaceutical grade microcrystalline cellulose product is produced by performing steps a through g above, and then:

h) neutralizing a solution of the hydrolyzed cellulose and water to obtain a neutralized solution having a pH of at least 5.5, and preferably between 5.5 and 7.5,

i) applying a shear force to deaggregate particles and provide a more uniform hydrolyzed cellulose material, and

j) spray drying the hydrolyzed cellulose.

During the cooking process at high temperature, the lignocellulosic material undergoes controlled hydrolysis to obtain hydrolyzed cellulose. In certain embodiments of the present invention, the hydrolysis can be accelerated or slowed down by the presence of acids or bases during the cooking. In further embodiments, an oxidation also can take place at the same time if the environment is favourable.

In another embodiment, a hydrolysis of hemicelluloses and lignin, if there are any left, may take place along with the hydrolysis of the amorphous zones of the cellulose, under the effect of the temperature and the acidity of the reaction medium. This hydrolysis may be more or less severe depending on the raw material, on the aqueous environment and obviously on the conditions of pressure, time and temperature applied during the treatment.

The hydrolysis can take place thanks to the organic acids such as acetic acid, freed by the thermal rupture of the acetyl groups of the hemicelluloses chains. Such organic acids may serve as catalysts for the hydrolysis of other products, notably cellulose.

This phenomenon is illustrated by the fact that the pH during steam cooking, goes rapidly from about 4.5 to 3.5 depending on the type of the pulp. A kraft pulp from softwood, for an equal treatment, will give a lower pH than a sulphite pulp from softwood, because of the higher content of hemicelluloses in the kraft pulp. Obviously, the extent of such effect depends on the severity of the applied treatment.

This is distinguished from the addition of known quantities of mineral acids to the reaction environment which can result in the same effect, but is very hard to control.

Oxidation of the product present in the process can take place with more or less intensity depending on the time of exposure to air, the temperature, the environment and the accessibility to the treated product. This oxidation can lead to degradation of products hence, to a cellulose product of lower quality than desired as well as lower yields.

The non-controlled oxidation can also give coloured products. It may also degrade or alter the product resulting in the production of oxycelluloses for example.

Types of Celluloses That Can be Treated by the Process of the Present Invention

The cellulose employed in the process of the present invention may be derived from a wide variety of cellulosic feedstock including but not limited to, wood and wood products, such as wood pulp fibres, non-woody paper-making fibres, from cotton, from straws and grasses, such as rice and esparto, from canes and reeds such as bagasse, from bamboos, from stalks with bast fibres, such as jute, flax, kenaf, cannabis, linen and ramie, and from leaf fibres such as abaca and sisal.

Suitable wood sources include softwood sources such as pines, spruces and firs, and hardwood sources such as oaks, eucalyptuses, poplars, beeches and aspens.

Bleached, partially bleached or non bleached celluloses from resinous or hardwoods, and resulting from chemical processes such as kraft process or sulphite as well as cellulose resulting from alternative processes such as steam explosion treatment may also be used.

Types of Additives That Can be Used with the Present Process

In certain embodiments, a suitable antioxidant may be used, for the purpose of the present invention. More particularly, any other product having antioxidant function and that is acceptable with the desired applications of the finished products and compatible with the operation conditions may be used.

Preferably, these antioxidants may be selected from the group consisting of:

Propyl gallate,

Hydroquinone,

Sodium sulfite, and

Citric acid.

Commercial products such as EDTA and Dequest from Monsanto may also be used in the process of the present invention.

Steps of the Process

The pulp used as the starting material of the process of the present invention can be prepared by repulping the cellulose in water in the presence or absence of an additive, antioxidant or sequestrant, in a reactor mixed with the recirculation pump working at a 2% to 3% consistency

The repulped pulp is pumped towards a pressing system such as a screw press or any other device allowing the pulp to drain and lowering the moisture of the fibre to 70% or less in weight (wet basis).

The humid pulp is then decompacted and aerated on a shredder or a coarse grinder. The reactor is then pre-heated to the temperature desired or to any other temperature chosen to reduce the condensation due to the heating of the walls during the treatment. This can be done via the jacket of the reactor or by injecting vapour directly and then emptying the reactor before opening it to charge it.

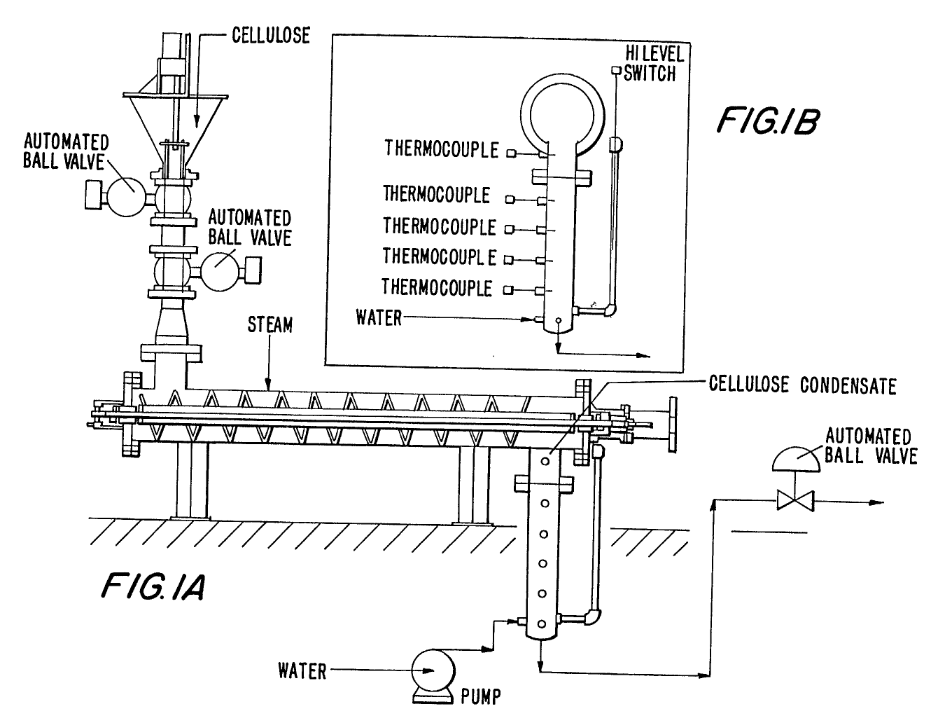

The reactor is then fed with wet grounded pulp. In a preferred embodiment, an apparatus such as that shown in FIG. 1 is used. The reactor can be fed in continuous mode, in which the feeding is done through an airlock or by any other mechanism allowing feeding of a vessel that is under pressure, for example a co-axial system. The reactor can also be fed in a batch mode with the reactor closed. In certain embodiments, vacuum can be applied before the steam feed to purge the gases present, such as air.

The reactor is then fed with steam directly up to a predetermined pressure. This method allows to rapidly reach a temperature between 200° and 235° C.

In certain embodiments where a batch reactor is used, a purge of non-condensables, through the top of the reactor, is desirable if the purge was not carried out. Furthermore, steam must be re-introduced in the reactor to maintain the pressure.

The cooking is maintained during about 4 to 25 minutes depending on the nature of the cellulose and the chosen working temperature. The goal is to reach a stable degree of polymerisation indicative of reaching the desired degree of polymerization (DP) for microcrystalline cellulose (MCC). As one of ordinary skill in the art will appreciate, however, the cooked pulp itself is not MCC. Rather, the cooked pulp is hydrolyzed cellulose, which can be subsequently processed and dried to form MCC.

In the case of batch mode, the reactor is then rapidly cooled by an injection of water in the jacket and in the reactor itself. A preliminary depressurisation of the excess vapour can also be carried out before the injection of cooling water.

In the case of continuous mode, the treated product is pushed to one or several partially decompressed chambers for partial decompression. This insures the transport of the product towards the exit, without causing any explosion. The product can thereafter be cooled down by water injection and further transported for the next step.

In one embodiment of the present invention a variant of the decompression chambers may be carried out by means of a set of screw spindles and/or gears and/or inverted pump. This variant insures a rapid cooling of the product by a partial decompression with no explosion of the latter.

The mixing can then start and the reactor is cooled down to around 60° C. by adding water to recover all the cellulose present in the reactor.

When the treated pulp is a pulp of sulphite or bleached kraft quality, it preferably is sent directly to filtration before going to “brightening” and/or bleaching.

In the case of a pulp of intermediate quality, it is preferable to treat the pulp with a caustic soda solution that is diluted in a way to eliminate leftover lignin and other impurities present, after which the pulp is filtered, then washed before being sent to bleaching, which will be done according to the initial quality of the starting cellulose.

After filtration, the product is brightened with hydrogen peroxide, for example using the following conditions:

Peroxide: 2% w/w on dry mass;

Magnesium sulphate: 0.5% w/w on dry mass; and

Sodium hydroxide: 0.5% w/w on dry mass.

The treatment could be done between 60 and 120° C. and under air or oxygen pressure reaching up to 120 psi.

The brightening and bleaching process can be adapted in function of the quality of the initial product, and in the more extreme cases, known bleaching methods can be used, such as hypochlorite or chlorine dioxide bleaching. The bleaching consistency will preferably be 25% but this can also be done at lower consistencies.

The bleached pulp (e.g., bleached hydrolyzed cellulose) is filtered and may be used as such or in a dry state for new applications comprising a new generation of microcrystalline cellulose of fibrous appearance, but having the same specifications as a classical microcrystalline cellulose in crystallinity index and DP.

The filtered pulp can also be homogenized in water at a consistency from 0.5 to preferably 3% and then filtered and washed to rid the residue of bleaching reactives. Prior to the homogenization step, the pH of the solution is adjusted with hydrochloric acid (HCL) or, ammonium hydroxide (NH₄OH), so as to obtain a pH at least 5.5 and preferably between 5.5 and 7.5 (with the particular pH being dependent upon the initial pH of the solution and the desired pH of the final product). In any event, the filtered pulp (which is hydrolyzed cellulose) is homogenized by subjecting the solution of filtered pulp and water to sufficient shear force to deaggregate the hydrolyzed cellulose particles, thereby providing a more uniform hydrolyzed cellulose material. Preferably, the shear force is applied with an apparatus of the blender type or colloid mill, which allows the separation (e.g, deaggregation) of hydrolyzed cellulose particles to produce non-colloidal microcrystalline cellulose when subsequently dried.

After filtration, the suspension obtained is brought to a dryer of the type “spray dryer” to obtain the size required in the desired dryness of classical microcrystalline cellulose, for instance at a consistency of 10 to 20%.

The following shows representative results which can be obtained using the process of the present invention. Of course, these results can vary depending on the desired properties of the microcrystalline cellulose.

Results: Yield of MCC Obtained by the Process of the Invention

| | ALPHA 93 | KRAFT |
|---|---|---|
| Repulping | 100 | 100 |
| Hydrolysis and washing | 95.0 | 88.0 |
| H₂O_{2 and washing} | 99.0 | 99.0 |
| NaOCl and washing | | 99.0 |
| (if needed) | | |
| Homogenization | 99.5 | 98.5 |
| Drying | 99.5 | 99.0 |
| Total Yield | 93.1 | 84.1 |

As seen above, there can be an increase in the yield of the alfa-pulp of 20% and an increase in the yield of the kraft pulp of 23% compared to the thermo-mechanical pulping process using steam explosion treatment.

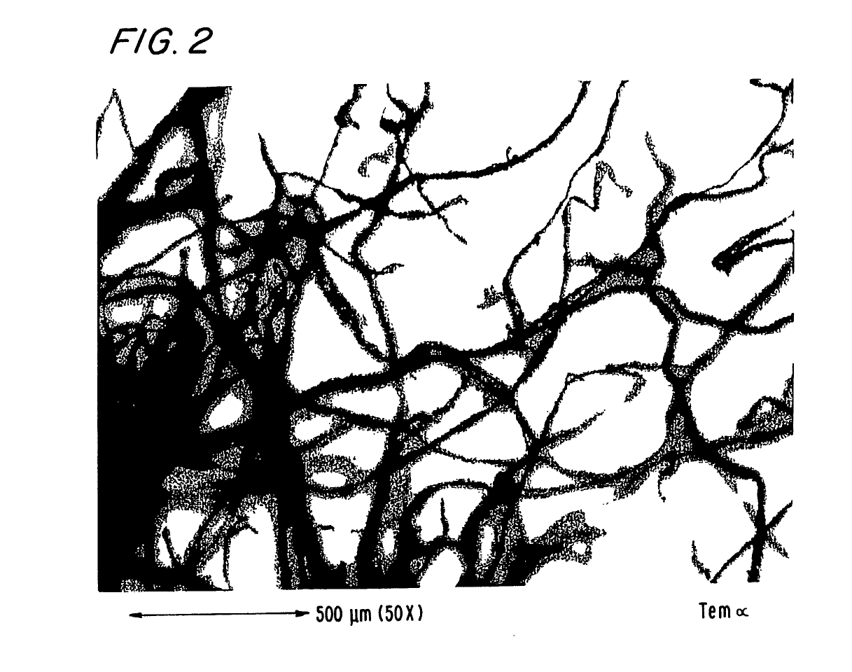

FIG. 2 shows the fibrous appearance of the Temalfa cellulose 93 TEM at the natural state.

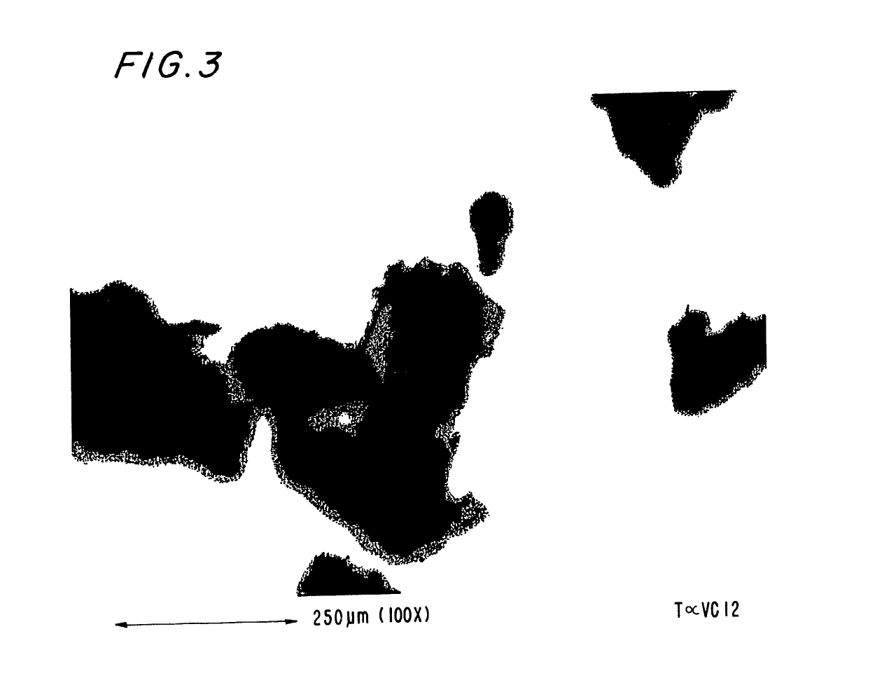

FIG. 3 shows the fibrous appearance of the Temalfa cellulose 93 TEM when it is treated with a process comprising a thermo-mechanical pulping step.

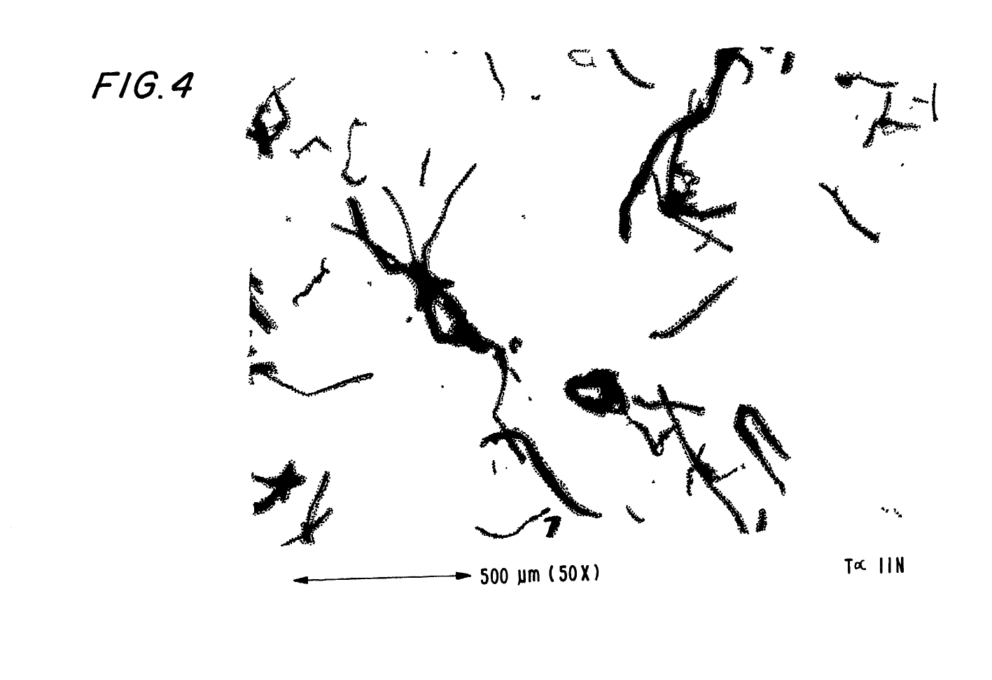

FIG. 4 shows the fibrous appearance of the Temalfa cellulose 93 TEM when it is treated with the process of the present invention.

Applications of the Microcrystalline Cellulose Obtained by the Process of the Present Invention

If the bleached hydrolyzed cellulose is homogenized (e.g, via a blender or colloidal mill) and spray dried to form microcrystalline cellulose, it has similar applications to conventional microcrystalline cellulose such as Avicel PH 101, or Emcocel 50 M. For example:

Tableting (excipient with bonding properties);

Cream used in pharmaceuticals and cosmetics;

Fat replacer (lipid free ice cream and mayonnaise);

Chromatography support; and

Complexation with transition metals for enzyme immobilisation.

If the bleached hydrolyzed cellulose is not treated (e.g., not homogenized or spray dried), a fibrous microcrystalline cellulose product is achieved that is of very high purity and that may serve as a support for a new type of catalyst.

Since the structure of the product has a fibrous aspect and that, contrary to classical MCC, OH groups from the anhydroglucose molecule are not available, they will not react with the metals used to obtain a catalyst. Furthermore, in mixing this preparation with inorganic products for a sufficient mixing and drying time, the distribution of the active sites formed then dried and charred, will be different than the one obtained with a classical microcrystalline cellulose conferring new properties to the finished product. The spherical substrate of the catalyst, after charring, contains holes of controlled dimension making it different than the one obtained with colloidal MCC or with ground cellulose, which is, on top of that, limited by its initial inferior quality.

In preferred embodiments, the process of the present invention can provide for one or more of the following:

Steam cooking of humidified cellulose that is saturated in water.

Cooking without any mineral acids or dioxides.

Presence or absence of additives (e.g. antioxidant).

No explosion of the treated product.

It is applicable to many types of cellulose of deciduous or resinous trees.

Cooking of the humidified cellulose with saturated vapour.

Controlled cooking allowing to obtain the desired degree of polymerization of the cellulose.

Very short time of treatment thanks to the instantaneous heating of the cellulose with saturated vapour.

Limited vapour consumption that is 1 to 1.2 ton of vapour per ton of dry cellulose.

Contrary to the thermo-mechanical pulping, this new process can prevent exposure of burst material to air, to light, or to the hot metallic sides. Therefor, there is no possible or very little formation of oxycelluloses, which is favoured in the presence of metals at these temperatures. Moreover, when the pulp is subjected to violent depressurisation such as going from 350 psi to atmosphere pressure in a few fractions of second, such as in the case of thermo-mechanical pulping, the substance is treated in a destructive fashion. This also has an abrasive effect on the material of the reactor located near the exit, thus increasing the chance for the treated product to be contaminated with metallic particles.

The addition of certain cooking additives can help to avoid even more oxidation of the cellulose and its impurities.

Very low formation of colour on the treated product with the recommended process.

Increased efficiency of washing (which means reduction of water quantities used).

A degree of brightness of the finished bleached product higher than any other treatment by steam explosion.

If need be, a homogenisation of the finished product can be carried out and the breaking of the cellulose chains is done in a methodical manner contrary to what is done by classical thermo-mechanical pulping with the random explosion of cells as well as with the shear and the impact produced by the violent depressurisation.

In a particular embodiment, alpha 93 pulp can produce a yield of the initial dry pulp of 95% at the hydrolysis including the washing whereas with an explosive process where in the best of the cases as disclosed in patent no. CA 2,313,261 this yield is at best of 87% under similar conditions.

In another embodiment using kraft pulp, a yield under similar conditions of 88% can be obtained versus 83% by steam explosion treatment.

As one of ordinary skill in the art will appreciate, in order to be considered suitable for use in pharmaceutical products, a microcrystalline cellulose product must conform to the definition of microcrystalline cellulose in the United States Pharmacopoeia 24/National Formulary 19 (USP/NF). The USP/NF sets forth a standard test for determining compliant microcrystalline cellulose. For example, the USP/NF has requirements relating to i) total aerobic microbial count; ii) conductivity; iii) pH; iv) loss on drying; v) residue on ignition (ROI); vi) bulk density; vii) water solubility; and viii) ether solubility. In the context of the present invention, a pharmaceutical grade microcrystalline cellulose product is a product that complies with the requirements of USP/NF.

However, in addition to being USP/NF compliant, it is also desirable for a microcrystalline cellulose product to be equivalent or superior to the existing commercial standard microcrystalline cellulose products in terms of compaction and powder flow. Currently, there are two commercial standards for pharmaceutical grade microcrystalline cellulose: Emcocel 50 M, manufactured by Penwest Pharmaceuticals and Avicel PH 101, manufactured by FMC Corp. Therefore, in the context of the present invention, a commercially acceptable pharmaceutical grade microcrystalline cellulose product is a produce that complies with the requirements of USP/NF, and which has equivalent or superior compaction and powder flow to at least one of Avicel PH 101 and Emcocel 50 M.

As set forth above, a a commercially acceptable pharmaceutical grade microcrystalline cellulose product can be prepared in accordance with an embodiment of the present invention by performing the steps of:

a) preparing a pulp by repulping

b) pressing the pulp obtained in a

c) decompacting the pulp obtained in b

d) feeding the pulp obtained in c into a pre-heated reactor

e) cooking the pulp at a temperature, a time, and a pressure sufficient to obtain a pulp having a desired degree of polymerization;

f) cooling and partially depressurizing the reactor by purging the reactor, followed by a water injection into the jacket and directly into the reactor;

g) filtering the pulp obtained in step f

h) neutralizing a solution of the hydrolyzed cellulose and water to obtain a neutralized solution having a pH of at least 5.5, and preferably between 5.5. and 7.5;

i) applying a shear force to deaggregate the hydrolyzed cellulose particles and thereby provide a more uniform hydrolyzed cellulose material, and

j) spray drying the hydrolyzed cellulose to obtain a commercially acceptable pharmaceutical grade microcrystalline cellulose product.

In this regard, it is believed that performing the homogenization step (step i) after the filtration (step g) facilitates the production of a commercially acceptable pharmaceutical grade microcrystalline cellulose product.

### EXAMPLES OF TRIALS CARRIED OUT BY THE PROCESS OF THE INVENTION

A) TEMALFA 93 cellulose: small scale test without additives

B) TEMALFA 93 cellulose: small scale test with additives

C) Kraft cellulose: small scale test without additives

D) TEMALFA 93 on a commercial scale without additives.

E). Q 90 Domtar Pulp: continuous mode manufacture

The Temalfa 93 cellulose from Tembec Company is obtained by the sulfite process from resinous trees. Given its quality, its standards of whiteness, its purity and its low content in resin, this pulp can be easily used in the production of carboxy-methyl cellulose, of methyl cellulose and of microcrystalline cellulose (MCC) for the grades 100 or 200. This pulp is characterised in that it gives a degree of polymerisation of the MCC in the vicinity of 225.

Temalfa 93 is the most commonly used feedstock around the world for the fabrication of microcrystalline cellulose in classical processes using mineral acid.

The composition of the Temalfa cellulose is the following:

| | |
|---|---|
| Pentosans: | 2.40% |
| Ashes: | 0.05% |
| S10 at 25 C.: | 8.6% |
| S8 at 25 C.: | 5.6% |
| Alpha cellulose | 92.5% |

The kraft cellulose from Donohue at 100% resinous has the following composition:

| | |
|---|---|
| Pentosans: | 7.00% |
| Ashes: | 0.36% |
| Alpha cellulose: | 89%. |

Domptar pulp may also be used in the context of the present invention.

### A—Example 1

### TEMALFA 93 Cellulose

1 kg of Temalfa 93 cellulose was repulped at a consistency of 2.5% in water, then partially dried with the help of a press and coarsely grounded to obtain a residual moisture of 60.3%.

From the above-obtained product, 229 g (equivalent to 90.913 g of cellulose) were introduced in a 24 litres reactor pre-heated with saturated steam. The steam is then introduced directly from the bottom of the reactor and a rapid purge is carried out to evacuate the non condensables.

Within 1 minute the product reached a temperature of 220° C. where it is maintained for 13 minutes. The pressure is then partially released and pressurised cold water is injected in the reactor in such a way as to allow rapid cooling of the pulp. Mixing is initiated at this stage to ensure an homogeneous discharge and to carry on to the next step of the treatment. The washed filtered product (252 g at 65.7% moisture) is white, slightly greyish.

The pH of the filtered solution is 5.3.

Using a sample of 59.7 g a brightening with hydrogen peroxide was carried out with 2% peroxide in the presence of 0.5% magnesium sulphate (on a dry pulp basis) at a pH of 10.5. The operation was carried out for 1 hour at 60° C.

After filtration and washing, 56.7 g of pulp is recovered (64.2% moisture).

A homogenization of 55.7 g of brightened pulp with a blender gives, after filtration and washing, 50.7 g of pulp at 60.8% moisture (19.9 g of dry product).

Analysis

DP (Degree of Polymerisation)=214

Cr.I (Crystallinity Index)=84.6

MS (Microcrystal Size)=46.6 Å

### B—Example 2

### Temalfa 93 Cellulose with Additives

A solution of 1% sodium sulphite is used at a ratio of 20/1 on 100 g of Temalfa cellulose. After pressing and coarse grinding, 214 g of soaked cellulose at 75.3% moisture is introduced into the pre-heated reactor.

The product is treated as in the example 1 for 12 minutes. After filtration and washing, 363 g of pulp at 75.3% moisture is obtained and the pH of the filtrate is 4.3.

357 g of bleached pulp obtained above is brightened with peroxide at the same conditions as in example 1. After washing and filtration, 253.3 g of pulp is recovered (moisture=65.5%).

A homogenisation is carried out with 250 g of brightened pulp described above and after filtration and washing, 237.7 g of pulp is recovered (64% moisture).

Analysis

DP=219

Cr.I=88.9

MS=46.6 Å

### C—Example 3

### Kraft Cellulose

210 g of kraft cellulose humidified at 55.8% is treated at 220° C. for 13 minutes.

After filtration and washing, 366.4 g of cellulose are recovered at 77.7% moisture. The pH of the filtered solution is 4. The cellulose obtained is coloured, light brown/caramel.

A brightening step is carried out with the same conditions as previously described. A bleaching step is then carried out with hypochlorite with 1% hypochlorite (on dry cellulose basis) at a pH of 11 at 40° C. during 2 hours. The filtered bleached product has a weight of 237.5 g and a humidity of 66.2%. The homogenisation allowed the recovery of 240.4 g of pulp at 67.1% humidity.

Analysis

DP=224

Cr.I=88.8

MS=43.1 Å

### D—Example 4

### Example at a Commercial Scale

120 kg of Temalfa 93 cellulose was repulped in the reactor mixed with cold water at a consistency of 3%. The operation is done in 6 steps of repulping of 20 kg each.

The pulp is then sent to a screw press of Atara/Spirac Spiropress U-260 brand to be dried up to a residual humidity of approximately 65%. The wet cellulose obtained goes through a moulding granulator that will decompact it.

The product obtained is loaded in a cylindrical stainless steel reactor. The reactor's volume is 2 cubic meters. After having closed the reactor, it is directly fed with steam to obtain the pressure required for the treatment. In just a few minutes the temperature into the reactor reaches 220° C.

After 12 minutes of cooking at 220° C., water is injected in the reactor in order to lower the temperature rapidly and allow a discharge of the cooking product. The discharge of the reactor is done several times with water injection to allow for a complete recuperation of the product.

4 cubic meters of water are required to complete this operation.

A rotating filter of 0.9 meter diameter and 0.6 meter length is then used for the filtration and the washing of the cellulose that is obtained.

The product has a fibrous aspect, reflecting from a non-destructive process. It is whitish.

Analysis

DP=214

Cr.I=85.2

MS=46.6 Å.

### E—Example 5

### Microcrystalline Cellulose Manufacture in Continuous Mode

20 kg of Q 90 Domtar pulp was re-pulped at a consistency of 3% in water, than partially dried with the help of a press and coarsely ground to obtain residual moisture of 64%.

The reactor is heated up to 220° by direct steam injection and the rate of the screw is determined to have a residence time of 16 minutes.

The moist cellulose is fed to the hopper during 6 hours accordingly with the opening cycle of the ball valves. The cooked product is exits the reactor accordingly with water cycle. At the same time, water is injected into the vessel above the reactor. When the water reaches predetermined level into the vessel the ball valves opens and closes without loss of steam through the valve.

The product is then filtered on rotary filter and the sequence of washing and bleaching with hydrogen peroxide continues. After adjustment to pH 6.5 with ammonium hydroxide the microcrystalline cellulose is finally homogenised into a colloid mill and then dried into a commercial spray drier in order to give an average powder of 50 microns.

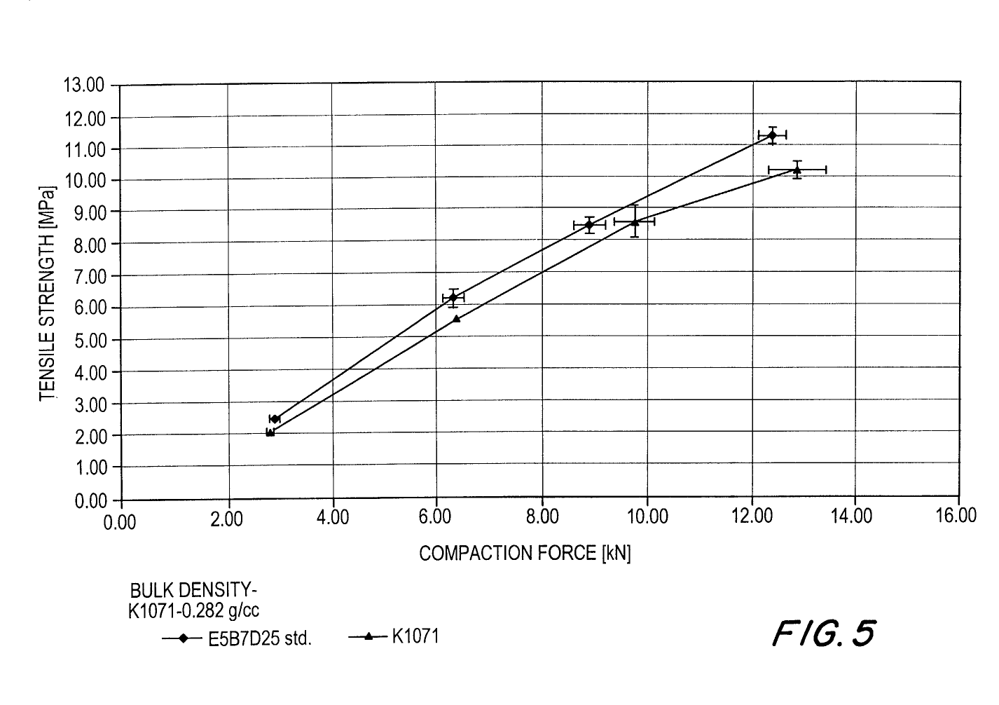

As illustrated in FIG. 5, MCC made in accordance with Example E has comparable characteristics to the commercial standard Emcocel 50M manufactured by Penwest Pharmaceuticals. Specifically, the MCC of Example E and Emcocel 50 M MCC were each tableted on a Korsch PH106 instrumented tablet press. In each case the MCC was tableted “neat” (i.e., without any additives such as lubricants, etc). ⅜″ flat face punches were used on the tablet press and tablet dimensions and hardness were measured on a Erweka TBH-30 Tablet Tester. The results of the tests are set forth in Tables 1 and 2 below, and in FIG. 5:

TABLE 1
Emcocel 50 M

| Compaction | Std. dev. | Tensile | Std. dev. |
|---|---|---|---|
| force (kN) | (kN) | strength (Mpa) | (Mpa) |
| 2.89 | 0.10 | 2.49 | 0.09 |
| 6.29 | 0.21 | 6.23 | 0.28 |
| 8.87 | 0.31 | 8.49 | 0.24 |
| 12.38 | 0.26 | 11.34 | 0.25 |

TABLE 2
Example E

| Compaction | Std. dev. | Tensile | Std. dev. |
|---|---|---|---|
| force (kN) | (kN) | strength (Mpa) | (Mpa) |
| 2.81 | 0.07 | 2.07 | 0.08 |
| 6.36 | 0.14 | 5.61 | 0.31 |
| 9.74 | 0.39 | 8.60 | 0.50 |
| 12.85 | 0.55 | 10.25 | 0.28 |

Referring to FIG. 5, it can be observed that the compaction characteristics of Example E are quite comparable to Emcocel 50 M. Similarly, the flow characteristics of Example E are quite comparable to Emcocel 50 M. As one of ordinary skill in the art will appreciate, the flow characteristics can be derived from the x and y axis error bars (which in turn are derived from the compaction force and tensile strength standard deviation), with the smaller error bars indicative of better flow characteristics.

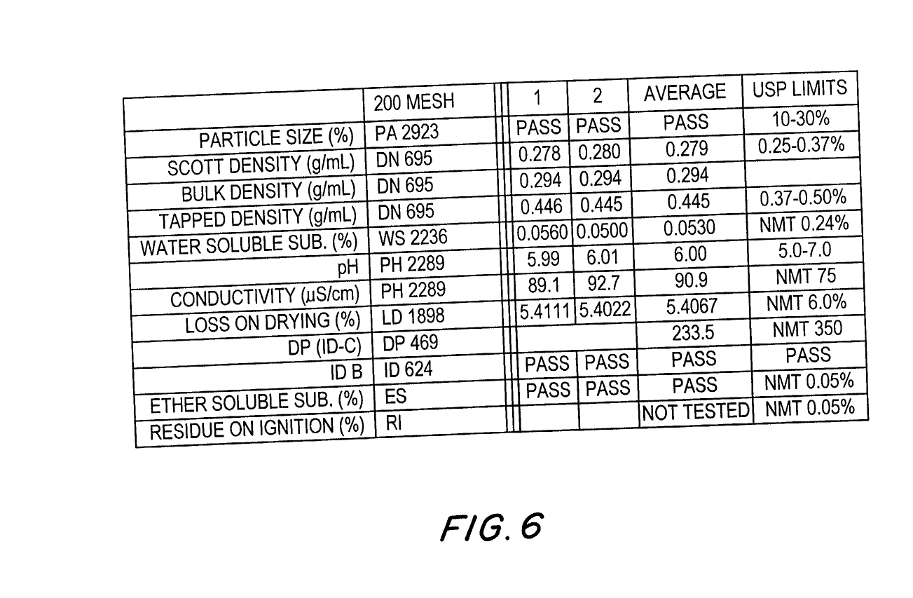

FIG. 6 sets forth the results of the USP/NF tests on Example E with regard to Particle Size (%), Scott Density (g/mL), Bulk Density (g/mL), Tapped Density (g/mL) , Water Soluble Sub. (%), pH , Conductivity (S/cm), Loss on Drying (%), ID test C, ID test B, Ether Soluble Sub. (%), and Residue on Ignition (%).

As one of ordinary skill in the art will appreciate, the data in FIGS. 5 and 6 indicate that the process used to product Example E is suitable for producing a commercially acceptable pharmaceutical grade microcrystalline cellulose product.

Although the present invention has been explained hereinabove by way of a preferred embodiment thereof, it should be pointed out that any modifications to this preferred embodiment within the scope of the present description is not done to alter or change the nature and scope of the present invention.

1. A process for preparing a commercially acceptable pharmaceutical grade microcrystalline cellulose comprising:
a) repulping a pulp, the pulp having a composition,
b) pressing the pulp obtained in a),
c) decompacting of the pulp obtained in b),
d) feeding the pulp obtained in c) into a pre-heated reactor,
e) cooking the pulp in the reactor until the pulp obtains a desired degree of polymerization, said cooking being performed at a temperature, a time, and a pressure which is a function of the desired degree of polymerization and the composition of the pulp, the cooked pulp being hydrolyzed cellulose;
f) partially depressurizing the reactor;
g) injecting water into the reactor,
h) discharging the hydrolyzed cellulose from the reactor,
i) filtrating the hydrolyzed cellulose,
j) deaggregating the hydrolyzed cellulose of step i; and
k) drying the hydrolyzed cellulose to form microcrystalline cellulose.

2. The process of claim 1, wherein the step of deaggregating comprises applying a shear force.

3. The process of claim 1, wherein the step of deaggregating is performed with a colloid mill.

4. The process of claim 1, wherein the step of drying is performed with a spray dryer.

5. The process of claim 1, further comprising, prior to the deaggregating step, adding water to the hydrolyzed cellulose of step i to form a solution, neutralizing the solution to a pH of 5.5 or greater

6. The process of claim 5, wherein the step of deaggregating comprises feeding the solution of hydrolyzed cellulose and water into a colloid mill.

7. The process according to claim 1, wherein the repulping step is performed at a consistency of 2 to 3%.

8. The process according to claims 1, wherein antioxidants are added during the cooking step.

9. The process according to claim 1, wherein the cooking temperature varies from 210° to 235° C. as a function of the desired degree of polymerization and the composition of the pulp.

10. The process according to claim 1, wherein the cooking time varies between 4 and 25 minutes as a function of the desired degree of polymerization and the composition of the pulp.

11. The process of claim 1, further comprising, after the filtrating step, bleaching the hydrolyzed cellulose.

12. A process for preparing microcrystalline cellulose comprising:
a) repulping a pulp, the pulp having a composition,
b) pressing the pulp obtained in a),
c) decompacting of the pulp obtained in b),
d) feeding the pulp obtained in c) into a pre-heated reactor,
e) cooking the pulp in the reactor until the pulp obtains a desired degree of polymerization, said cooking being performed at a temperature, a time, and a pressure which is a function of the desired degree of polymerization and the composition of the pulp, the cooked pulp being hydrolyzed cellulose;
f) partially depressurizing the reactor;
g) injecting water into the reactor,
h) discharging the hydrolyzed cellulose from the reactor,
i) filtrating the hydrolyzed cellulose,
j) feeding the hydrolyzed cellulose into a colloid mill; and
k) drying the hydrolyzed cellulose to form microcrystalline cellulose.

13. The process according to claim 12, wherein the repulping step is performed at a consistency of 2 to 3%.

14. The process according to claims 12, wherein antioxidants are added during the cooking step.

15. The process according to claim 12, wherein the cooking temperature varies from 210° to 235° C. as a function of the desired degree of polymerization and the composition of the pulp.

16. The process according to claim 12, wherein the cooking time varies between 4 and 25 minutes as a function of the desired degree of polymerization and the composition of the pulp.

17. The process of claim 12, further comprising, after the filtering step, bleaching the hydrolyzed cellulose.

18. The process of claim 1, wherein the bleaching step is performed with a mixture of peroxide, magnesium sulphate and sodium hydroxide.

19. The process of claim 18, wherein the bleaching step is performed at a temperature between 60° and 120° C.

20. The process of claim 19, wherein the bleaching step is performed with an air pressure of 120 psi.

21. The process of claim 12, wherein the bleaching step is performed with a mixture of peroxide, magnesium sulphate and sodium hydroxide.

22. The process of claim 21, wherein the bleaching step is performed at a temperature between 60° and 120° C.

23. The process of claim 22, wherein the bleaching step is performed with an air pressure of 120 psi.

24. The process of claim 5, wherein the solution is neutralized to a pH of between 5.5 and 7.5.

25. The process of claim 12, further comprising, prior to the deaggregating step, adding water to the hydrolyzed cellulose of step i to form a solution, neutralizing the solution to a pH of 5.5 or greater.

26. The process of claim 25, wherein the solution is neutralized to a pH of between 5.5 and 7.5.

27. The process of claim 1, wherein the desired degree of polymerization is a stable degree of polymerization.

28. The process of claim 1, wherein the desired degree of polymerization is a stable degree of polymerization.
